(19) United States
(12) Patent Application Publication
(10) Pub. No.: US 2008/0205195 A1
(43) Pub. Date: Aug. 28, 2008

(54) Method of Amplitude Modulating a Message Signal in the Audible Frequency Range Onto a Carrier Signal in the Ultrasonic Frequency Range

(76) Inventor: Jacobus Johannes Van Der Merwe, Pretoria (ZA)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/065,162

(22) PCT Filed: Aug. 28, 2006
(86) PCT No.: PCT/IB2006/052982

§ 371 Date: Feb. 28, 2008

(30) Foreign Application Priority Data
Aug. 29, 2005 (ZA) 200506913

(51) Int. Cl. H04B 1/02

(52) U.S. Cl. 367/137

(57) ABSTRACT

This invention relates to signal processing and to acoustics. The invention provides a method of amplitude modulating a message signal (12) in the audible frequency range of a human onto a carrier signal (14) in the ultrasonic frequency range, the method including generating an amplitude modulated signal (20.1) having a constant envelope on one side (72). The invention extends also to a method of amplitude modulating a message signal (12) in the audible frequency range of a human onto a carrier signal (14) in the ultrasonic frequency range, the method including generating an amplitude modulated signal (20.2) having a constant level (33) defined successively by an upper and lower envelope of the amplitude modulated signal (20.2). The invention also extends to related amplitude modulators (10) and (110) and also to a related acoustic system (50).

THIS INVENTION relates to signal processing and to acoustics. In particular the invention relates to a method of amplitude modulation, to an amplitude modulator and to an acoustic system.

According to one broad aspect of the invention, there is provided a method of amplitude modulating a message signal in the audible frequency range of a human onto a carrier signal in the ultrasonic frequency range, the method including generating an amplitude modulated signal having a constant envelope on one side.

The term ‘envelope’ in this context is understood to indicate a curve that connects to either all local maxima or all local minima of the amplitude modulated signal. The term ‘constant envelope’ therefore indicates that either all local maxima or all local minima are of equal amplitude. In other words, if the local maxima of the amplitude modulated signal vary in accordance with the message signal then the local minima of the amplitude modulated signal are at a fixed amplitude relative to zero amplitude, and vice versa.

The side on which the envelope is constant may be either the upper side or the lower side of the amplitude modulated signal.

By “audible frequency range of a human” it will be understood that what is meant is the frequency range which is audible by a human being where air is the medium of transmission, the range being roughly between 20 Hz and 20 KHz. It will be understood that “ultrasonic frequency range” will be all those frequencies above the audible frequency range of a human where air is the medium of transmission i.e. greater than 20 KHz.

The method as described above may include:
offsetting the carrier signal relative to a zero amplitude level, prior to modulation, thereby generating an offset carrier signal;
offsetting the message signal relative to a zero amplitude level, prior to modulation, thereby generating an offset message signal; and
modulating the offset message signal onto the offset carrier signal, thereby to generate the amplitude modulated signal having a constant envelope on one side.

It will be appreciated by those skilled in the art that by “offsetting”, what is meant is introducing a DC bias to a signal.

It will be further appreciated by those skilled in the art that “modulation” or “modulating” in the time domain is understood to mean multiplication or multiplying respectively, whereas in the frequency domain “modulation” or “modulating” is understood to mean the operation of convolution or convoluting respectively.

A carrier signal modulated with conventional prior art double sideband amplitude modulation (DSB AM) may be expressed as u_{conventional}(t)=[m(t)]cos(2πf_{c}t+φ_{c}). It will be appreciated that for a non-constant message signal (m(t)), both the upper envelope and the lower envelope of the modulated signal (u_{conventional}(t)) will be non-constant, with the upper envelope and the lower envelope being mirror images of one another.

The signal modulated by the method as described above may be expressed as uᵢₙᵥₑₙₜᵢₒₙ(t)=A_{c}[1+m(t)][1+cos(2πf_{c}t+φ_{c})]+c, where |m(t)⊕≦1, In this embodiment it is assumed that the average value of the carrier signal and message signal is effectively at zero amplitude. The carrier signal and message signal are offset by one, such that the lower boundary of the amplitude range of each of the message signal and of the carrier signal is effectively shifted to zero amplitude. In this embodiment, the lower envelope of the carrier signal will be constant. The modulated signal uᵢₙᵥₑₙₜᵢₒₙ(t) may have any convenient offset (C). It will be appreciated that if c=0, the lower envelope will correspond with an effective zero amplitude level. If, however, C≠0, the lower envelope of the carrier signal will be offset from the effective zero amplitude level by an offset amplitude value of c. The method may therefore include offsetting the amplitude modulated signal relative to a constant amplitude level by an offset level such that after offsetting thereof, the amplitude of the amplitude modulated signal has an average value centred between positive and negative values of the applied voltage.

The method may include the prior step of controlling the maximum instantaneous amplitude of the message signal prior to offsetting thereof by automatically adjusting the gain of the message signal to a pre-selected target maximum amplitude level, so as to optimise the modulation index of the modulated signal. By optimising the modulation index, what is meant is that the modulation index may be automatically increased and/or decreased, by electronic means, if and when necessary. It will be appreciated that the maximum amplitude of the message signal is directly related to the modulation index.

The method may include feeding the amplitude modulated signal to a transducer to transmit the amplitude modulated signal into a transmission medium. It will be understood that a plurality of transducers such as a transducer array may be used. The method as described above may be used with transducers with a wide or narrow bandwidth. It will be understood that if a directional transducer is used, a transducer beam spread may be calculated from conventional transducer beam spread equations.

The method may include amplifying the amplitude modulated signal by way of a differential signal amplifier, prior to feeding the amplitude modulated signal to the transducer. The differential signal amplifier may include an inverting amplifier, and a non-inverting amplifier. The inverting and non-inverting amplifiers will usually have the same amplification factor, for example Y. The differential signal amplifier may effectively multiply the voltage of the amplitude modulated signal by the amplification factor of up to 2*Y. It will be appreciated that the peak-to peak voltage output level of the differential amplifier may be higher than the supply voltage used in the system, for example the peak-to-peak output voltage of the differential amplifier may be 18 Volts even though the power supply is limited to 10 Volts.

It will be understood that generating the amplitude modulated signal may include generating a continuous sinusoidal-type curve.

According to another aspect of the invention there is provided a method of amplitude modulating a message signal in the audible frequency range of a human onto a carrier signal in the ultrasonic frequency range, the method including generating an amplitude modulated signal having a constant level defined successively by an upper and lower envelope of the amplitude modulated signal.

The constant level may be a zero amplitude level.

The method may include:

offsetting the carrier signal relative to a zero amplitude level, prior to modulation, thereby generating an offset carrier signal; and

modulating the message signal onto the offset carrier signal, thereby to generate an amplitude modulated signal having a constant level defined successively as an upper and lower envelope of the amplitude modulated signal.

The signal modulated by the method as described above may be expressed as uᵢₙᵥₑₙₜᵢₒₙ(t)=A_{c}[m(t)][1+cos(2πf_{c}t+φ_{c})]. It will be appreciated that this particular modulation method results in a suppressed carrier.

The method may include controlling the maximum instantaneous amplitude of the message signal prior to offsetting thereof by automatically adjusting the gain of the message signal to a pre-selected target maximum amplitude level, so as to optimise the modulation index of the modulated signal.

The method may include feeding the amplitude modulated signal to a transducer to transmit the amplitude modulated signal into a transmission medium. It will be understood that a plurality of transducers such as a transducer array may be used. Preferably, this method may be used with transducers with a wide bandwidth.

The method may include amplifying the amplitude modulated signal by way of a differential signal amplifier, prior to feeding the amplitude modulated signal to the transducer.

It will be understood by those skilled in the art that an equivalent amplitude modulation method can be performed in the frequency domain as the method above described in the time domain, bearing in mind that the operation of multiplication in the time domain, is equivalent to the operation of convolution in the frequency domain, as mentioned above. The frequency domain modulation method will lead to the same result as if done in the time domain.

It will be appreciated that the amplitude modulated signal, as described above, creates deflections on the basilar membrane of a human ear similar to the deflections that would have been created on the basilar membrane by the message signal alone such that, in use, the ear of a listener would be able automatically to demodulate the amplitude modulated signal and the listener would be able to hear the message signal without external demodulation circuitry. In this regard, the method as described above may take into consideration biological characteristics of the cochlea and basilar membrane in the human ear.

According to another aspect of the invention there is provided an amplitude modulator for amplitude modulating a message signal in the audible frequency range of a human onto a carrier signal in the ultrasonic frequency range, the amplitude modulator being configured to modulate the message signal onto the carrier signal, thereby to generate an amplitude modulated signal having a constant envelope on one side.

The amplitude modulator may include:
carrier signal offset means connected to a carrier signal input, the carrier signal offset means being operable, prior to modulation, to offset the carrier signal relative to a zero amplitude level;
message signal offset means connected to a message signal input, the message signal offset means being operable, prior to modulation, to offset the message signal relative to a zero amplitude level; and
amplitude modulation means operable to modulate the offset message signal onto the offset carrier signal.

The amplitude modulator may also include an amplitude modulated signal offset means connected to an output of the amplitude modulation means, the amplitude modulated signal offset means being operable to offset the amplitude modulated signal relative to a constant amplitude level, after modulation, by an offset level such that after offsetting thereof, the amplitude of the amplitude modulated signal has an average value centred between positive and negative values of an applied voltage.

The amplitude modulator may also include an automatic gain controller (AGC) connected between the message signal input and the message signal offset means.

The amplitude modulator may include a carrier signal generator operable to generate an ultrasonic carrier signal with a frequency at least twice the maximum frequency of the message signal. In another embodiment of the invention, the carrier signal may be a squared sinusoidal wave such that the amplitude modulated signal is expressed as uᵢₙᵥₑₙₜᵢₒₙ(t)=A_{c}[1+m(t)][cos²(2πf_{c}t+φ_{c})]+c, where |m(t)|≦1. It should be noted that in this embodiment the carrier signal's frequency would double by the squaring process.

Alternatively, or in addition, a diode, a digital signal processor (DSP), message signal clipping means operable to clip the modulated signal against supply voltages, or the like, may be used to generate the amplitude modulated signal with a constant envelope on one side.

According to another aspect of the invention there is also provided an amplitude modulator for amplitude modulating a message signal in the audible frequency range of a human onto a carrier signal in the ultrasonic frequency range, the amplitude modulator being operable to modulate the message signal onto the carrier signal, thereby to generate an amplitude modulated signal having a constant level defined successively by an upper and lower envelope of the amplitude modulated signal.

The amplitude modulator may include:
carrier signal offset means connected to a carrier signal input, the carrier signal offset means being operable, prior to modulation, to offset the carrier signal relative to a zero amplitude level; and
amplitude modulation means operable to modulate the message signal onto the offset carrier signal.

The amplitude modulator may also include a carrier signal generator operable to generate an ultrasonic carrier signal with a frequency at least twice the maximum frequency of the message signal so as to prevent aliasing.

It will be appreciated that the carrier signal may typically be sinusoidal but other waveforms may also be used such as a square wave carrier, an impulse wave carrier, a triangular wave carrier, a ramp wave carrier, a half wave rectified sinusoidal carrier, a full wave rectified sinusoidal carrier, or the like. However, it will be understood that the carrier signal having a non-sinusoidal waveform will usually lead to the creation of harmonics.

The amplitude modulator may also include an automatic gain controller (AGC) connected to a message signal input.

According to another aspect of the invention there is provided an acoustic system which includes:
an amplitude modulator as described above, the amplitude modulator having an output; and
an acoustic transducer or transducer array having an input operatively connected to the output of the amplitude modulator.

The acoustic system may include differential amplifier having an input connected to the output of the amplitude modulator and having an output connected to the acoustic transducer or transducer array. It will be appreciated by those skilled in the art that by making use of the differential signal amplifier, the noise immunity of the system may be improved.

The acoustic system, acoustic transducer or transducer array may be capable of being submersed in liquid such that, in use, the acoustic system may be operable to communicate with a person submerged underwater.

The transducer array may include a plurality of directional acoustic transducers which are arranged side-by-side in substantially aligned relationship to one another to permit emission of a signal in a particular direction of emission. It will be understood that the transducers as described above may be ultrasonic transducers.

According to another aspect of the invention, there is provided a method of amplitude modulating a message signal in the audible frequency range of a human onto a carrier signal in the ultrasonic frequency range, the method including generating an amplitude modulated signal, the amplitude modulated signal varying between positive and negative values of a supply voltage and having an average value of zero, such that if the message signal is positive, all local maxima of the amplitude modulated signal vary in accordance with the message signal while the local minima of the amplitude modulated signal are fixed at zero amplitude, and, if the message signal is negative, all local minima of the amplitude modulated signal vary in accordance with the message signal while the local maxima of the amplitude modulated signal are fixed at zero amplitude.

The invention will now be further described, by way of example, with reference to the following diagrammatic drawings.

In the drawings:

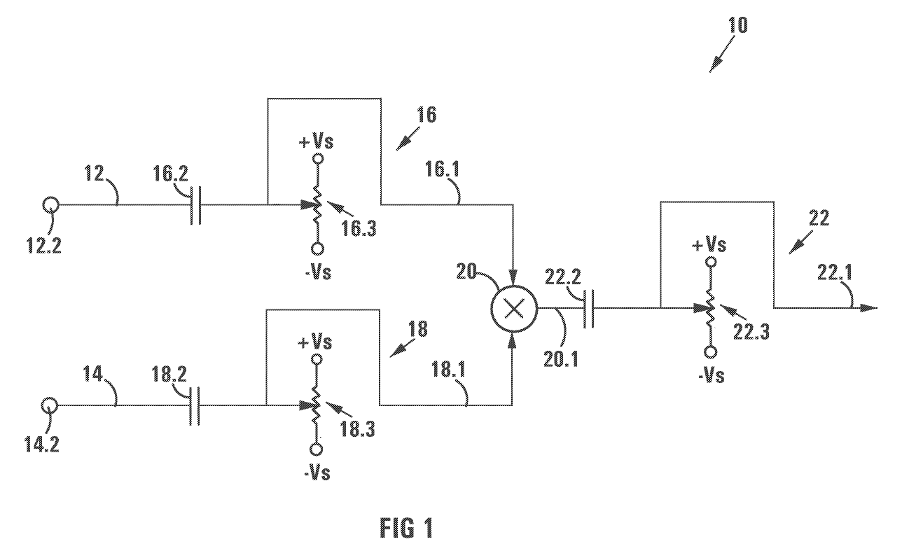

FIG. 1 shows a schematic circuit diagram of one embodiment of a modulator, in accordance with the invention;

FIG. 2 shows a time domain representation of an arbitrary audio message signal;

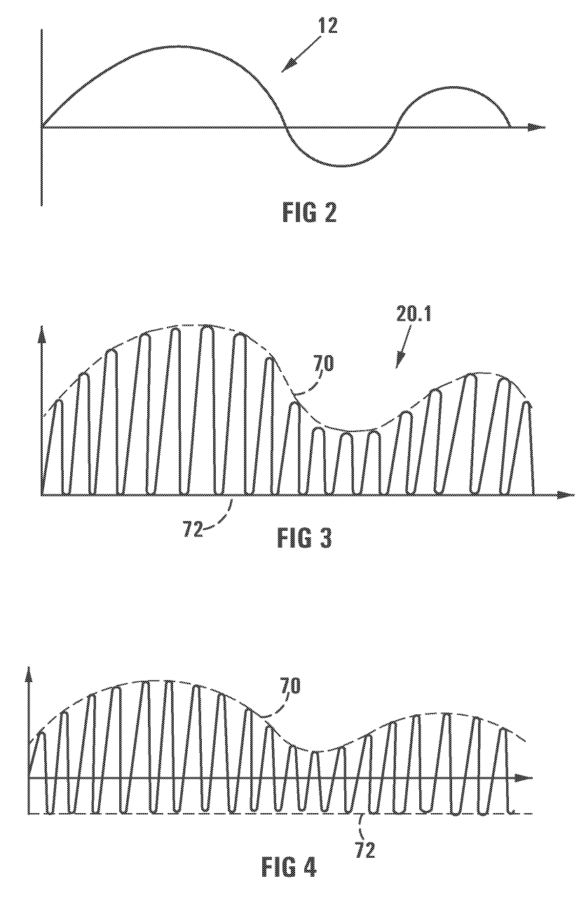

FIG. 3 shows a diagram of a modulation signal in the time domain with a constant envelope on one side in accordance with the invention;

FIG. 4 shows a diagram of an offset modulation signal in the time domain with a constant envelope on one side in accordance with the invention;

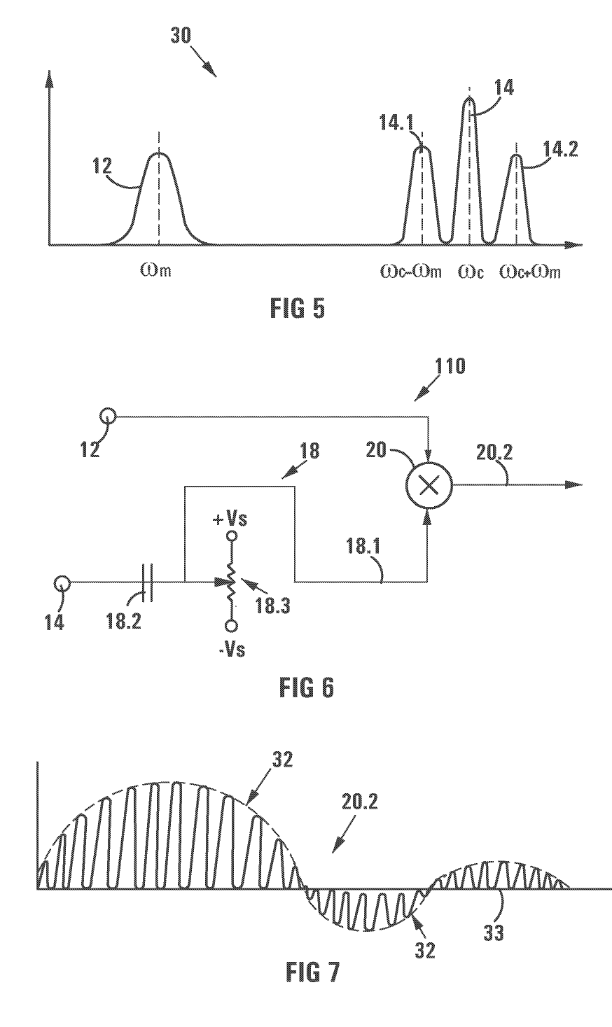

FIG. 5 shows a diagram of a frequency spectrum of the modulation signal with a constant envelope on one side in accordance with the invention;

FIG. 6 shows a schematic circuit diagram of another embodiment of a modulator in accordance with the invention;

FIG. 7 shows a diagram of a modulated signal in the time domain having a constant level defined successively by an upper and lower envelope of the amplitude modulated signal;

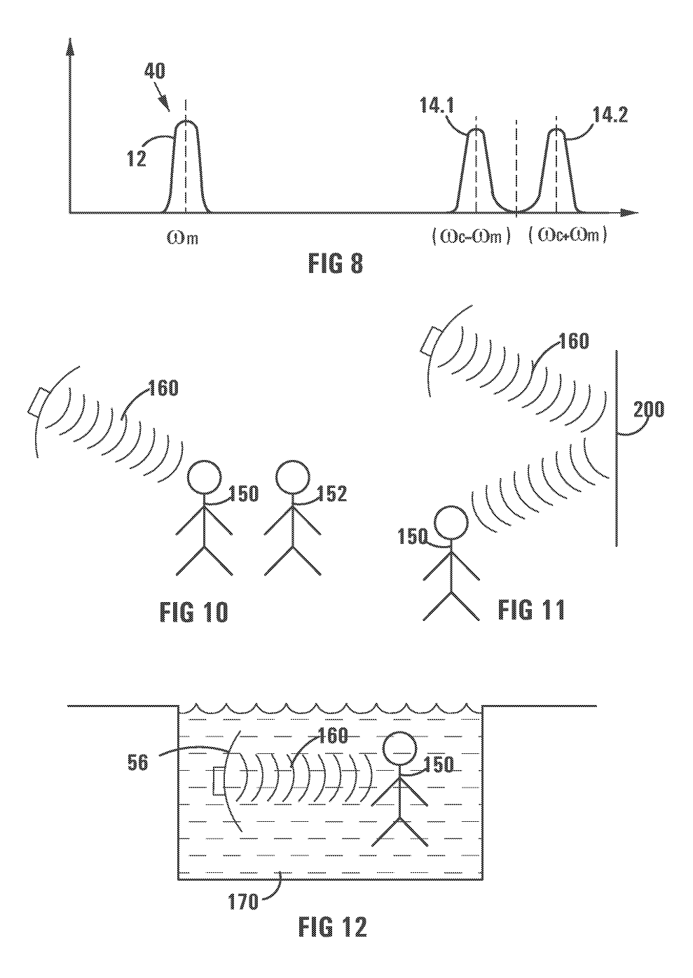

FIG. 8 shows a diagram of a frequency spectrum of the modulation signal with a constant level defined successively by an upper and lower envelope of the amplitude modulated signal;

FIG. 9 shows a schematic circuit diagram of an acoustic system in accordance with the invention; and

FIGS. 10 to 12 show schematic diagrams of acoustic systems in accordance with the invention, in use.

Referring to FIGS. 1 to 5 of the drawings, an amplitude modulator is generally referred to by reference numeral 10 (see FIG. 1), the amplitude modulator being operable to modulate a message signal onto a carrier signal to produce an amplitude modulated signal. It will be understood that amplitude modulated signal and modulated signal will refer to the same thing.

The modulator 10, receives a message signal input 12 (m(t)), shown in FIG. 2, and a carrier signal input 14 (A_{c}(cos(2πf_{c}t+φ_{c})) ), via terminals 12.2 and 14.2 respectively. It will be noted that A_{c} denotes the amplitude of the carrier signal 14, f_{c} its frequency and φ_{c} its phase. The message signal 12 and the carrier signal 14 are fed to message and carrier signal offset means in the form of level shifters 16 and 18, respectively. The outputs 16.1, 18.1 from the level shifters 16,18 respectively, are fed into an amplitude modulation means in the form of a multiplier 20. An output signal 20.1 from the multiplier 20 is fed to modulated signal offset means in the form of level shifter 22. The level shifters 16, 18, 22 include capacitors 16.2, 18.2, 22.2 and variable resistors 16.3, 18.3, 22.3 operating between the positive and negative values of the supply voltage Vₛ viz. ±Vₛ. The level shifters 16, 18, 22 are operable to shift the respective input signals thereto between ±Vₛ.

The message signal 12 is an audible signal which falls within the audible frequency range of a human i.e. roughly between 20 Hz to 20 KHz. The message signal will typically range between known amplitude boundaries, |m(t)|≦1 in this particular example.

The carrier signal 14 is an ultrasonic frequency which is in the ultrasonic frequency range i.e. generally those frequencies greater than 20 KHz. The carrier signal 14 is generated by a carrier signal generator (not shown) and is preferably at least twice that of the maximum frequency of the message signal, so as to avoid aliasing. In this particular embodiment of the invention, the carrier signal frequency is about 40 KHz i.e. f_{c}=40 KHz. Other carrier signal frequencies may also be used, for example 60 KHz or 80 KHz, depending on the type of transducer used. Preferably, the carrier signal 14 is a sinusoidal signal, but other signal waveforms may also be used. For example a square wave carrier signal, a triangular wave carrier signal, a half wave rectified sinusoidal carrier signal, a full wave rectified sinusoidal carrier signal, a ramp wave carrier signal, or the like may be used. It will be noted, however, that non-sinusoidal waveforms produce unwanted harmonics.

It will be understood that if the message signal is continuous and if the carrier signal is a sinusoidal signal (e.g. a sine wave or cosine wave), the modulated signal will be a continuous sinusoidal-type curve having local maxima and/or minima which vary in amplitude.

In use, the level shifter 16 introduces a DC offset/bias to the message signal 12 thereby to shift the level of the message signal 12. The level shifter 16 offsets the message signal by one Volt. Thus, the output 16.1 from the level shifter 16, in this particular example, is m(t)+1, the offset message signal thus ranging now between zero and two Volts. The level shifter 18 also introduces a DC offset/bias to the carrier signal 14 thereby to shift the level of the carrier signal 14 such that the output 18.1 from the level shifter 18 is A_{c}(1+cos(2πf_{c}t+φ_{c})). The offset message signal 16.1 is then modulated onto the offset carrier signal 18.1 by multiplying the offset message signal 16.1 and the offset carrier 18.1 together by way of the multiplier 20. The resultant signal output 20.1 from the multiplier 20 is the amplitude modulated signal with the constant envelope on one side. This amplitude modulated signal 20.1 may be expressed as uᵢₙᵥₑₙₜᵢₒₙ(t)=A_{c}[1+m(t)][1+cos(2πf_{c}+φ_{c})]+offset, where |m(t)|≦1, as shown in FIG. 3 of the drawings. The amplitude modulated signal 20.1 is offset by way of level shifter 22, from a position as shown in FIG. 3 to the position as shown in FIG. 4. It will be understood that the modulated signal 20.1 is offset such that the average amplitude of the signal 20.1 is roughly centred between the supply voltage ±Vₛ.

The modulator 10 as described above may find application with transducers with a narrow or wide bandwidth.

In FIGS. 3 and 4, reference numeral 70 refers to an upper envelope and reference numeral 72 refers to a lower envelope. The maxima of the modulated signal define an upper envelope 70 which has the same shape as the message signal 12. The minima of the modulated signal define a lower envelope 72 which is constant. In another embodiment (not shown) the upper envelope 70 could be constant and the lower envelope 72 could have the same shape as the message signal. It will be noted that, unlike the prior art amplitude modulators, the modulated signal is not a mirror image on opposite sides because the amplitude varies on one side only.

In FIG. 5, a frequency spectrum of the modulation as described above is generally referred to by reference numeral 30. It can be seen that in addition to the carrier signal 14 being present at ω_{c} and the lower and upper sidebands 14.1 and 14.2 at (ω_{c}−ωₘ) and (ω_{c}+ωₘ) respectively, the message signal 12 is also present at ωₘ.

Referring to FIGS. 6 to 8 of the drawings, where unless otherwise indicated similar parts will be referred to by the same reference numerals as in previous Figures. Another embodiment of an amplitude modulator as described above is generally referred to by reference numeral 110. The amplitude modulator 110 differs from amplitude modulator 10 (in FIG. 1) in that only the carrier signal 14 is offset by way of the level shifter 18 to give the offset carrier 18.1 i.e. A_{c}(1+cos(2πf_{c}t+φ_{c})). Another difference is that the amplitude modulator 110 does not have a modulated signal level shifter 22 (as in FIG. 1) at the output thereof to shift the modulated signal 20.2, shown in FIG. 7.

In use, the message signal 12 is modulated onto the offset carrier 18.1 by way of the multiplier 20 to give the resultant signal 20.2, FIG. 7, which may be expressed as uᵢₙᵥₑₙₜᵢₒₙ(t)=A_{c}[m(t)][1+cos(2πf_{c}t+φ_{c})].

The modulator 110 may find particular application with transducers with a wide bandwidth.

In FIG. 7, reference numeral 32 refers to the envelope of the amplitude modulated signal 20.2. The envelope 32 having a constant level 33 defined successively as an upper and lower envelope of the amplitude modulated signal. In this particular embodiment of the invention the constant level 33 is the zero amplitude level.

In FIG. 8, reference numeral 40 generally refers to a frequency spectrum of the modulation as described above. It will be appreciated that the frequency spectrum 40 differs from the frequency spectrum 30 (FIG. 5) in that the carrier 14 is suppressed in this particular embodiment of the invention.

Referring to FIG. 9 to 12 of the drawings, where unless otherwise indicated similar parts will be referred to by the same reference numerals as in previous Figures, an acoustic system as described above is generally referred to by reference numeral 50. The acoustic system 50 includes a message signal input 12.1 operable to receive/generate a message signal 12; a carrier signal generator 14.1 operable to generate a carrier signal 14; a level shifter 16 in electronic communication with the message signal input 12 via an automatic gain controller (AGC) 52; a level shifter 18 in electronic communication with the carrier signal generator 14.1; a multiplier 20 operable to receive signals 16.1, 18.1 from the lever shifters 16 and 18 respectively; a differential amplifier 54 operable to receive an output modulated signal 20.1, 20.2 from the multiplier 20, the differential amplifier including a signal inverter 54.1 and two audio amplifiers 54.2; and a transducer array 56 which the receives an amplified modulated signal 54.3 from the differential amplifier 54.

In use, the message signal 12 is passed through the AGC 52 which automatically increases or decreases the gain of the message signal 12 so that the instantaneous peak amplitude value of the message signal 12 conforms to a pre-selected amplitude value of the message signal 12. The message signal 12 is thereafter offset by way of the level shifter 16. The ultrasonic sinusoidal carrier signal 14 is generated by the signal generator 14.1 and is offset by one by operating the variable resistor 18.3 of the level shifter 18. The outputs 16.1, 18.1 from the level shifters 16, 18 respectively, are then multiplied together by the multiplier 20 to generate the modulated signal 20.1 or 20.2 as described above. Should the modulated signal 20.1 be required at the output of the multiplier 20, the variable resistor 16.3 is operated such that the message signal is offset by one to give the resultant modulated signal 20.1 i.e. uᵢₙᵥₑₙₜᵢₒₙ(t)=A_{c}[1+m(t)][1+cos(2πf_{c}t+φ_{c})]+offset (as shown in FIG. 3) at the output of the multiplier 20. Should the modulated signal 20.2 be required at the output of the multiplier 20, the variable resistor 16.3 is operated to set the offset for the message signal 12 to zero to give the resultant modulated signal 20.2 i.e. uᵢₙᵥₑₙₜᵢₒₙ(t)=A_{c}[m(t)][1+cos(2πf_{c}t+φ_{c})] (as shown in FIG. 7) at the output of the multiplier 20. It will be understood that setting the variable resistor 16.3 to offset the message signal 12 to zero Volts is effectively the same as not including the level shifter 16, such as in the modulator 110 as shown in FIG. 6, in the generation of the modulated signal 20.2.

The modulated signal 20.1, 20.2 is then passed to a differential amplifier 54 which effectively amplifies and doubles the voltage of the modulated signal 20.1, 20.2. The differential amplifier 54 also reduces the noise which may result from long lead lines (not shown) to the transducer array 56. The transducer array 56 receives the amplified modulated signal 54.3 and transmits it as an acoustic wave 160 over a medium such as air, water, or the like. It will be noted that the transducer array 56 may be comprised of ultrasonic transducers. The acoustic wave 160 may be directional, dependant on the transducers used. It will be appreciated that if a piezo-electric transducer is used, transducer ringing can be avoided by using an amplifier, to drive the transducer, capable of delivering sufficient current in order to drain the ringing from the transducer.

In this particular embodiment of the invention, the modulated signal 20.1 need not be further offset (as in FIG. 1) as the differential amplifier 54 optimally positions the modulated signal 20.1 between the supply voltage ±Vₛ.

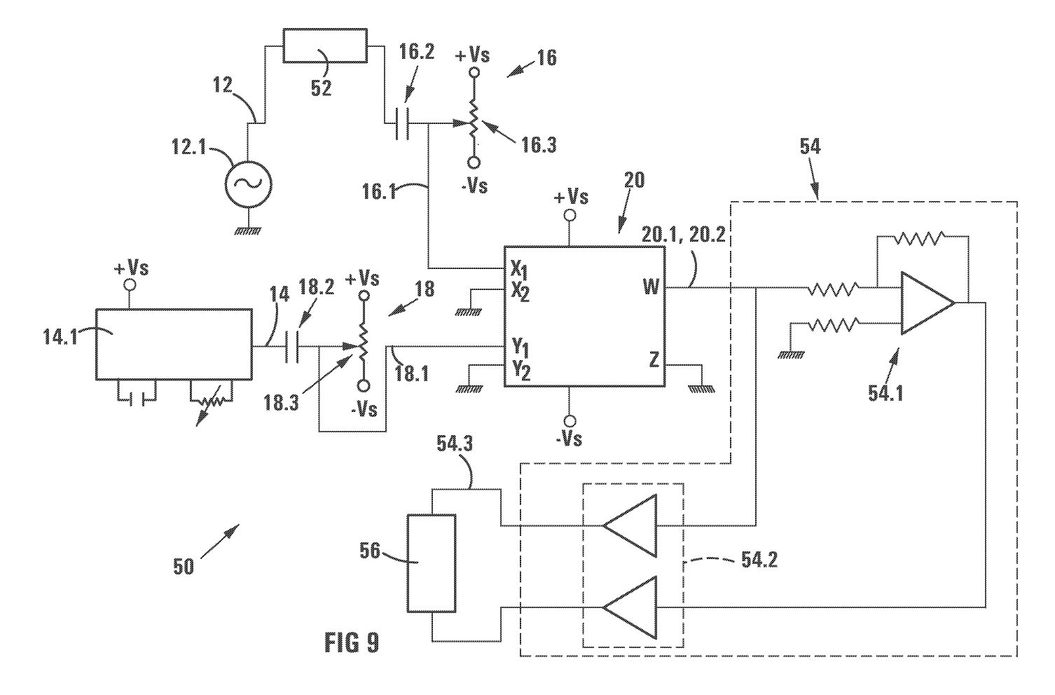

In FIGS. 10 to 12, an application of sound generated by means of the ultrasonic transducer array 56 (as shown in FIG. 9) is shown schematically. It will be noted that similar parts will be referred to by the same reference numerals. In FIG. 10, it can be seen that if directional ultrasonic transducers are used, the acoustic wave 160 can be directed at a particular individual 150 with limited scattering of the acoustic wave 160. As a result, the acoustic wave is automatically demodulated by the ear of the individual 150 and he/she hears the message signal 12 clearly only if standing in the path of the acoustic wave 160, whereas person 152 would not be able to demodulate the acoustic wave 160 and would therefore not be able to hear the message signal 12. It will be appreciated that the method as described above may be used with directional and omni-directional transducers). As mentioned above, the acoustic wave 160 is the amplified amplitude modulated signal 54.3 as emitted from the transducer array 56. In FIG. 11, it can be seen that the acoustic wave 160 can be reflected from a surface 200 thereby to create the impression that the sound is emitted from the surface 200 from which it is reflected. In other words a virtual sound source 200 is created in this way. In FIG. 12, a person 150 submerged in water 170 would also be able to demodulate the acoustic signal 160 emanating from a submerged transducer or transducer array 56 in his/her ear thus highlighting that the acoustic wave 160 may be demodulated by the human ear, irrespective of the medium through which the wave 160 travels.

The directional properties of the acoustic wave shown in FIG. 10 can be used in applications where sound is to be directed at a particular individual 150 in a group 150, 152, for example in advertising applications, crowd control applications, to permit transmission of an audible acoustic wave to an individual in the crowd, to ensure privacy of a telephone e.g. cellular telephone conversation, on a sports field, and so on. Also when sound is to be carried over a long distance the directional capabilities of ultrasonic sound can be used to limit loss of intensity of the acoustic wave.

The use of the acoustic system as described above in underwater application, as shown in FIG. 12, is particularly advantageous for divers, swimmers, or the like, to be able to communicate underwater.

It will be appreciated that the modulators as above described may be implemented on a digital signal processor, or microprocessor configuration that make use of an analogue to digital circuit to sample the message signal and a digital to analogue circuit for outputting the modulated signal. Various improvements are possible for example a means could be added to control the volume of the resulting audio output.

The inventor believes that the invention as illustrated will overcome the limitations of the prior art devices and methods in that it addresses the problem of modulating a message signal in such a manner that the message signal, when demodulated by the basilar membrane in the ear of a listener, is reproduced with limited or no distortion. The amplitude modulation method, as described above, takes into consideration biological characteristics of the cochlea and basilar membrane in the human ear. No electronic demodulation is required thus allowing a person to hear a modulated ultrasonic sound signal, which, it is believed, will be of superior quality to that produced by prior art acoustic systems.

The inventor further believes that the method, apparatus, and system as described above may be advantageously used to create highly directional sound, to create sound in a defined space, to create a virtual sound source, and to enable underwater audio communication with a human.

1. A method of amplitude modulating a message signal in the audible frequency range of a human onto a carrier signal in the ultrasonic frequency range, the method including generating an amplitude modulated signal having a constant envelope on one side.

2. A method as claimed in claim 1, wherein the side on which the envelope is constant is the upper side of the amplitude modulated signal.

3. A method as claimed in claim 1, wherein the side on which the envelope is constant is the lower side of the amplitude modulated signal.

4. A method as claimed in claim 1, in which generating of the amplitude modulated signal includes:
offsetting the carrier signal relative to a zero amplitude level, prior to modulation, thereby generating an offset carrier signal;
offsetting the message signal relative to a zero amplitude level, prior to modulation, thereby generating an offset message signal; and
modulating the offset message signal onto the offset carrier signal, thereby to generate the amplitude modulated signal having a constant envelope on one side.

5. A method as claimed in claim 4, which further includes offsetting the amplitude modulated signal relative to a constant amplitude level by an offset level such that after offsetting thereof, the amplitude of the amplitude modulated signal has an average value centred between positive and negative values of the applied voltage.

6. A method as claimed in claim 4, which includes the prior step of controlling the maximum instantaneous amplitude of the message signal prior to offsetting thereof by automatically adjusting the gain of the message signal to a preselected target maximum amplitude level, so as to optimise the modulation index of the modulated signal.

7. A method as claimed in claim 1, which includes feeding the amplitude modulated signal to a transducer to transmit the amplitude modulated signal into a transmission medium.

8. A method as claimed in claim 7, which includes amplifying the amplitude modulated signal by way of a differential signal amplifier, prior to feeding the amplitude modulated signal to the transducer.

9. A method as claimed in claim 1, in which generating the amplitude modulated signal includes generating a continuous sinusoidal-type curve.

10. A method of amplitude modulating a message signal in the audible frequency range of a human onto a carrier signal in the ultrasonic frequency range, the method including generating an amplitude modulated signal having a constant level defined successively by an upper and lower envelope of the amplitude modulated signal.

11. A method as claimed in claim 10, in which the constant level is a zero amplitude level.

12. A method as claimed claim 10, which includes:
offsetting the carrier signal relative to a zero amplitude level, prior to modulation, thereby generating an offset carrier signal; and
modulating the message signal onto the offset carrier signal, thereby to generate an amplitude modulated signal having a constant level defined successively as an upper and lower envelope of the amplitude modulated signal.

13. A method as claimed in claims 12, which includes controlling the maximum instantaneous amplitude of the message signal prior to offsetting thereof by automatically adjusting the gain of the message signal to a pre-selected target maximum amplitude level, so as to optimise the modulation index of the modulated signal.

14. A method as claimed in claim 10, which includes feeding the amplitude modulated signal to a transducer to transmit the amplitude modulated signal into a transmission medium.

15. A method as claimed in claim 14, which includes amplifying the amplitude modulated signal by way of a differential signal amplifier, prior to feeding the amplitude modulated signal to the transducer.

16. An amplitude modulator for amplitude modulating a message signal in the audible frequency range of a human onto a carrier signal in the ultrasonic frequency range, the amplitude modulator being configured to modulate the message signal onto the carrier signal, thereby to generate an amplitude modulated signal having a constant envelope on one side.

17. An amplitude modulator as claimed in claim 16, which includes:
carrier signal offset means connected to a carrier signal input, the carrier signal offset means being operable, prior to modulation, to offset the carrier signal relative to a zero amplitude level;
message signal offset means connected to a message signal input, the message signal offset means being operable, prior to modulation, to offset the message signal relative to a zero amplitude level; and
amplitude modulation means operable to modulate the offset message signal onto the offset carrier signal.

18. An amplitude modulator as claimed in claim 17, which includes an amplitude modulated signal offset means connected to an output of the amplitude modulation means, the amplitude modulated signal offset means being operable to offset the amplitude modulated signal relative to a constant amplitude level, after modulation, by an offset level such that after offsetting thereof, the amplitude of the amplitude modulated signal has an average value centred between positive and negative values of an applied voltage.

19. An amplitude modulator as claimed in claim 17, which includes an automatic gain controller (AGC) connected between the message signal input and the message signal offset means.

20. An amplitude modulator as claimed in claim 16, which includes a carrier signal generator operable to generate an ultrasonic carrier signal with a frequency at least twice the maximum frequency of the message signal so as to prevent aliasing.

21. An amplitude modulator for amplitude modulating a message signal in the audible frequency range of a human onto a carrier signal in the ultrasonic frequency range, the amplitude modulator being operable to modulate the message signal onto the carrier signal, thereby to generate an amplitude modulated signal having a constant level defined successively by an upper and lower envelope of the amplitude modulated signal.

22. An amplitude modulator as claimed in claim 21 which includes:
carrier signal offset means connected to a carrier signal input, the carrier signal offset means being operable, prior to modulation, to offset the carrier signal relative to a zero amplitude level; and
amplitude modulation means operable to modulate the message signal onto the offset carrier signal.

23. An amplitude modulator as claimed in claim 21, which includes a carrier signal generator operable to generate an ultrasonic carrier signal with a frequency at least twice the maximum frequency of the message signal.

24. An amplitude modulator as claimed in claim 21, which includes an automatic gain controller (AGC) connected to a message signal input.

25. An acoustic system which includes:
an amplitude modulator as claimed in claim 16, the amplitude modulator having an output; and
an acoustic transducer or transducer array having an input operatively connected to the output of the amplitude modulator.

26. An acoustic system as claimed in claim 25, which includes a differential amplifier having an input connected to the output of the amplitude modulator and having an output connected to the acoustic transducer or transducer array.

27. An acoustic system as claimed in claim 25, in which the acoustic system, acoustic transducer or transducer array is capable of being submersed in liquid.

28. An acoustic system as claimed in claim 25, in which the transducer array comprises a plurality of directional acoustic transducers which are arranged side-by-side in substantially aligned relationship to one another to permit emission of a signal in a particular direction of emission.

29. An acoustic system as claimed in claim 25, which the acoustic transducer is and ultrasonic transducer.

30. A method of amplitude modulating a message signal in the audible frequency range of a human onto a carrier signal in the ultrasonic frequency range, the method including generating an amplitude modulated signal, the amplitude modulated signal varying between positive and negative values of a supply voltage and having an average value of zero, such that if the message signal is positive, all local maxima of the amplitude modulated signal vary in accordance with the message signal while the local minima of the amplitude modulated signal are fixed at zero amplitude, and, if the message signal is negative, all local minima of the amplitude modulated signal vary in accordance with the message signal while the local maxima of the amplitude modulated signal are fixed at zero amplitude.
